(19) United States
(12) Patent Application Publication
(10) Pub. No.: US 2025/0278741 A1
(43) Pub. Date: Sep. 4, 2025

(54) SYSTEM AND FRAMEWORK FOR MULTICHANNEL VOICE OF CUSTOMER

(71) Applicant: FMR LLC, Boston, MA (US)

(72) Inventors: Chetan Vikram Mahajan, Holly Springs, NC (US); Vividh Pradeepbhai Talesara, Charlestown, MA (US); Paul Gerard O'Hara, Mansfield, MA (US); Dmitry Cypen, Needham, MA (US); Meghana Dharani Dharan, Cary, NC (US); Raghavendra Ramappa, Bengaluru, Karnataka (IN); Shashin Shivshankar Surkund, Cary, NC (US); Bibhash Chakrabarty, Kothanur, Bangalore (IN); Nishanth Kasaravalli Sreekantha, Bengaluru, Karnataka (IN)

(21) Appl. No.: 18/593,077

(22) Filed: Mar. 1, 2024

(51) Int. Cl. G06Q 30/01; G06F 16/31; G06F 16/35

(52) U.S. Cl. CPC G06Q 30/01; G06F 16/31; G06F 16/35

(57) ABSTRACT

A method for integrating customer interaction data from a plurality of channels and for a plurality of customers includes receiving a plurality of customer interaction records, each record associated with a channel and an identifier of a customer, each record including a customer interaction transcript; providing the plurality of customer interaction transcripts to a machine learning model; causing execution of the machine learning model, resulting in a model output including an interaction theme and an interaction summary associated with each one of the customer interaction transcripts; clustering the plurality of themes using a multi-level taxonomy, resulting in a plurality of clustered themes associated with each one of themes; mapping the pluralities of clustered themes and the plurality of interaction summaries, resulting in an interaction reason associated with each one of the customer interaction records; storing the interaction reason associated with each one of the customer interaction records in a database.

### BACKGROUND

### Technical Field

The present invention relates to voice-of-the-customer data integration, and more specifically to integration and analysis of voice-of-the-customer data from multiple channels.

### Background

The voice of the customer (VOC) summarizes customers' expectations, preferences, and concerns. Analyzing VOC data helps a business with identifying any emerging topics in their initial states before they become an issue. Analyzing VOC data also helps a business to be proactive in communicating trends and changes that may impact its customers. Further, VOC data helps a business with tracking customer activities to find potential friction points, such as technical issues or cybercrime. VOC enables a business to determine, for example, how customers engage with the business and what their preferred way of engagement is, where customers are getting frustrated and how they attempt to resolve the issue, what customers are doing before contacting the business, what needs and issue customers discuss the most, and many other questions.

Customer feedback, or VOC, is usually received over multiple channels, for example over the phone, online chat, email, virtual assistants, social media, etc. Solutions exist that analyze feedback for a single channel. For example, an existing solution may analyze VOC data from phone conversations. Another existing solution may analyze VOC data from online chats. A third existing solution may analyze VOC data received from social media. However, using different solutions for different interaction channels prevents integration of all VOC data to which a business has access.

### SUMMARY

The deficiencies of the prior art are remedied by providing a multichannel voice of customer framework that provides significantly improved integration and analysis capabilities for VOC data received over two or more different channels. In accordance with an embodiment of the present invention, a computer-implemented method for integrating customer interaction data from a plurality of channels and for a plurality of customers includes receiving, by a computer system, a plurality of customer interaction records, each record associated with a channel from the plurality of channels and an identifier of a customer from the plurality of customers, each record including a customer interaction transcript. The method includes providing, by the computer system, the plurality of customer interaction transcripts as inputs to a machine learning model. The method includes causing, by the computer system, execution of the machine learning model, the execution resulting in a model output including an interaction theme and an interaction summary associated with each one of the plurality of customer interaction transcripts. The method further includes clustering, by the computer system, the plurality of themes using a multi-level taxonomy, the clustering resulting in a plurality of clustered themes associated with each one of the plurality of themes. The method includes mapping, by the computer system, the pluralities of clustered themes and the plurality of interaction summaries, the mapping resulting in an interaction reason associated with each one of the plurality of customer interaction records. The method also includes storing, by the computer system, the interaction reason associated with each one of the plurality of customer interaction records in a database.

Alternatively, or in addition, the multi-level taxonomy is a hierarchical taxonomy. The multi-level taxonomy may include at least four levels.

Also alternatively, or in addition, the method further includes retrieving, by the computer system, a plurality of data records associated with the identifier of the customer from the database, each data record including a query interaction reason. The method includes aggregating, by the computer system, the plurality of data records by query interaction reason. The method also includes causing, by the computer system, display of the aggregated data.

Further alternatively, or in addition, the method further includes retrieving, by the computer system, a plurality of data records associated with a query interaction reason from the database, each data record including a query customer identifier. The method includes aggregating, by the computer system, the plurality of data records by query customer identifier. The method also includes causing, by the computer system, display of the aggregated data.

Alternatively, or in addition, at least one record of the plurality of customer interaction records is associated with a channel different from the channel associated with another record of the plurality of customer interaction records. The computer system may be configured to execute the method periodically. Each theme of the plurality of themes may include five words or less. Each summary of the plurality of summaries may include more than five words and less than twenty words.

In accordance with another embodiment of the present invention, a system for integrating customer interaction data from a plurality of channels and for a plurality of customers includes a database and a computer system having a processor coupled to a memory, The computer system is communicatively coupled to the database. The processor is configured to receive a plurality of customer interaction records, each record associated with a channel from the plurality of channels and an identifier of a customer from the plurality of customers, each record including a customer interaction transcript. The processor is configured to provide the plurality of customer interaction transcripts as inputs to a machine learning model. The processor is configured to cause execution of the machine learning model, the execution resulting in a model output including an interaction theme and an interaction summary associated with each one of the plurality of customer interaction transcripts. The processor is configured to cluster the plurality of themes using a multi-level taxonomy, the clustering resulting in a plurality of clustered themes associated with each one of the plurality of themes. The processor is configured to map the pluralities of clustered themes and the plurality of interaction summaries, the mapping resulting in an interaction reason associated with each one of the plurality of customer interaction records. The processor is configured to store the interaction reason associated with each one of the plurality of customer interaction records in the database.

Alternatively, or in addition, the multi-level taxonomy is a hierarchical taxonomy including at least four levels.

Also alternatively, or in addition, the processor is further configured to retrieve a plurality of data records associated with the identifier of the customer from the database, each data record including a query interaction reason. The processor is configured to aggregate the plurality of data records by query interaction reason. The processor is also configured to cause display of the aggregated data.

Further alternatively, or in addition, the processor is further configured to retrieve a plurality of data records associated with a query interaction reason from the database, each data record including a query customer identifier. The processor is configured to aggregate the plurality of data records by query customer identifier. The processor is also configured to cause display of the aggregated data.

Alternatively, or in addition, at least one record of the plurality of customer interaction records is associated with a channel different from the channel associated with another record of the plurality of customer interaction records. The processor may be configured to execute the method periodically. Each theme of the plurality of themes may include five words or less. Each summary of the plurality of summaries may include more than five words and less than twenty words.

In accordance with yet another embodiment of the present invention, a non-transitory computer-readable medium has software encoded thereon. The software, when executed by a computer system coupled to a database, is operable to receive a plurality of customer interaction records, each record associated with a channel from the plurality of channels and an identifier of a customer from the plurality of customers, each record including a customer interaction transcript. The software is operable to provide the plurality of customer interaction transcripts as inputs to a machine learning model. The software is operable to cause execution of the machine learning model, the execution resulting in a model output including an interaction theme and an interaction summary associated with each one of the plurality of customer interaction transcripts. The software is operable to cluster the plurality of themes using a multi-level taxonomy, the clustering resulting in a plurality of clustered themes associated with each one of the plurality of themes. The software is operable to map the pluralities of clustered themes and the plurality of interaction summaries, the mapping resulting in an interaction reason associated with each one of the plurality of customer interaction records. The software is operable to store the interaction reason associated with each one of the plurality of customer interaction records in the database.

### BRIEF DESCRIPTION OF THE DRAWINGS

The description below refers to the accompanying drawings, of which:

FIG. 1 is an illustration of a system for integrating customer interaction data in accordance with an embodiment of the present invention;

FIG. 2 is a flowchart of a method for integrating customer interaction data in accordance with an embodiment of the present invention;

FIG. 3 is an illustration of an exemplary transcript and associated machine learning and taxonomy outputs in accordance with an embodiment of the present invention;

FIG. 4 is an illustration of an exemplary taxonomy in accordance with an embodiment of the present invention;

FIG. 5 is an illustration of an exemplary taxonomy in accordance with an embodiment of the present invention;

FIG. 6 is an exemplary visualization of integrated data generated in accordance with an embodiment of the present invention; and

FIG. 7 is an illustration of a machine learning model architecture in accordance with an embodiment of the present invention.

### DETAILED DESCRIPTION OF ILLUSTRATIVE EMBODIMENTS

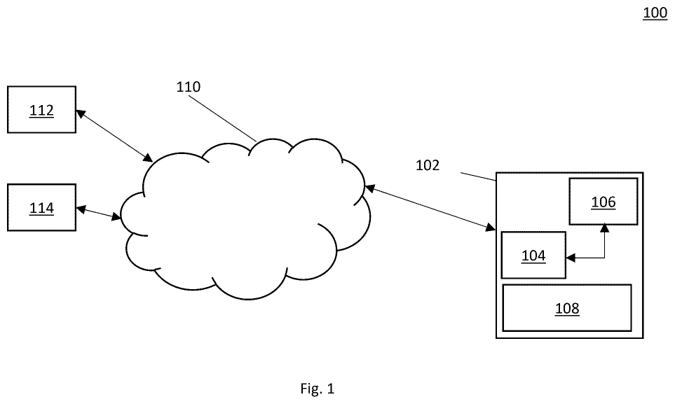

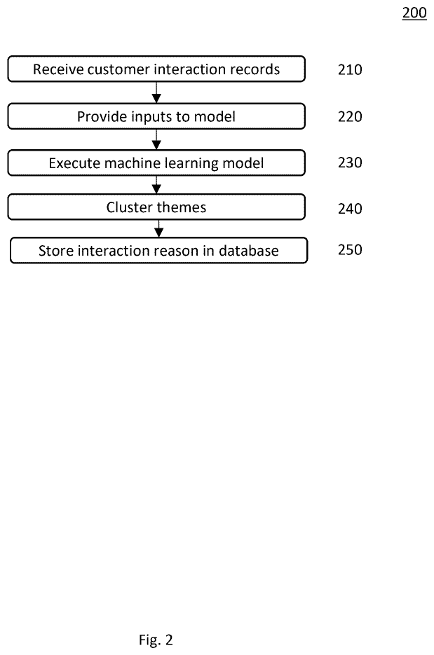

FIG. 1 is an illustration of a system 100 for integrating customer interaction data from a plurality of channels and for a plurality of customers in accordance with an embodiment of the present invention. System 100 includes a computer system 102. The computer system 102 has a processor 104 coupled to a memory 106. The computer system 102 may also be communicatively coupled to a communications network 110. Network 110 may be a public network, such as the internet, or it may be a private network, such as a network internal to a company. Network 110 also may be a combination of public and/or private networks. The computer system 102 may be coupled to the network 110 directly, for example via an Ethernet cable or via wireless connection such as Wi-Fi. Computer system 102 may also be coupled to the network 110 in any other way known to the skilled person, for example indirectly through another device (not shown), such as, but not limited to, a router, a switch, a hub, a separate computer system, a mobile device, a modem, and/or a combination of these devices. The processor 104 is configured to execute the method described below in detail with reference to FIG. 2. While a processor 104 is described herein, it is expressly contemplated that the computer system 102 has a plurality of processors. In that case, each of the plurality of processors of computer system 102 is coupled to the memory 106 and is configured to execute the method described below.

In some embodiments, computer system 102 further includes an integration module 108, executing on processor 104. In that case, the integration module 108 is configured to execute the method described below in detail with reference to FIG. 2. Integration module 108 may include specialized set of computer software instructions programmed onto one or more dedicated processors in computer system 102 and may also include specifically designed memory locations and/or registers for executing the specialized computer software instructions. Although integration module 108 is shown as part of and executing within computer system 102, it is expressly noted that the functionality of integration module 108 can be distributed among a plurality of computer systems. Computer system 102 enables integration module 108 to communicate with network 110 in order to exchange data for the purpose of performing the described functions. It should be appreciated that any number of computing devices, arranged in a variety of architectures, resources, and configurations (e.g., cluster computing, virtual computing, cloud computing) can be used without departing from the scope of the invention. Exemplary functionality of integration module 108 is described in detail throughout the specification.

Also communicatively coupled to the network 110 is a machine learning platform 112. The machine learning platform 112 may be accessed by the computer system 102 over the network 110 and enables the computer system 102 to cause execution of a machine learning model. Exemplarily, the machine learning platform 112 may be a commercially available machine learning platform that provides and executes one or more machine learning models. One example of such a publicly available platform is Amazon SageMaker, available at aws.amazon.com/sagemaker. This machine learning platform enables users to create, train, and deploy machine learning models in the cloud and/or on dedicated computing devices. The platform also allows for different levels of abstraction: it provides pre-trained machine learning models that may be used as is, it provides machine learning models that users may train on their own data, and it provides mechanisms to create machine learning models and algorithms from scratch. It is expressly noted, as further explained below, that any other suitable machine learning platform known to the skilled person, accessible either publicly or privately, may be used instead of or in addition to Amazon SageMaker.

Further coupled to the network 110 is a database 114. The database 114 may be provided by any publicly available database system known to the skilled person. It may be a commercial database or an open-source database. While the database 114 is shown here coupled to the network 110, it is also expressly contemplated that the database 114 may be hosted on the computer system 102. The database 114 allows the computer system 102 to store and retrieve data.

FIG. 2 is a flowchart of a computer-implemented method 200 for integrating customer interaction data from a plurality of channels and for a plurality of customers in accordance with an embodiment of the present invention. Specifically, method 200 may be executed by one or more processors 104 of computer system 102 as described above with reference to FIG. 1. Similar to what is described above, the computer system 102 is coupled to a communications network 110. Also coupled to the communications network 110, or hosted on the computer system 102, may be a machine learning platform 112 and a database 114, as described above. Also, in some embodiments and as described above, method 200 may be executed by an integration module 108 executing on one or more processors 104 of computer system 102. While computer system 102 is described herein as executing the method 200, it is expressly noted that the method 200 may also be executed by integration module 108.

In step 210, the computer system 102 receives a plurality of customer interaction records. These records include the incoming VOC data to be integrated and analyzed. Each record is associated with a channel from the plurality of channels and with an identifier of a customer from the plurality of customers. Illustratively, the identifier of the customer may be a customer number or any other suitable identifier, such as a social security number. In other embodiments, the identifier may be the name of the customer or a nickname, or a combination of various identifiers. The VOC data may be received over a variety of channels, such as over the phone, via online chat, email, interaction of a customer with a virtual assistant, social media chats and/or posts, interaction with a website, interaction with a mobile app, and/or any other channel known to the skilled person. A customer interaction record may include additional metadata, such as an identifier for the channel over which it was received or data related to actions the customer took during the interaction, such as account maintenance, transactions, money movement, or any other suitable action. Illustratively, at least one customer interaction record in the plurality of customer interaction records is associated with a channel different from the channel associated with another record of the plurality of customer interaction records. In other words, the plurality of customer interaction records received by computer system 102 includes at least two different channels.

In addition, each record includes a customer interaction transcript. The source and nature of the transcript corresponds to the channel over which the customer interaction took place. For example, an interaction over the phone channel in which a customer calls and interacts with a customer service representative over the phone may be automatically transcribed by a publicly available speech transcription software, such as software available from Nexidia, Inc. (Atlanta, GA). Such transcription software takes a digital recording of the call, archived or in real-time, as an input, recognizes the speech, and produces a textual transcript of the call. The textual call transcript is then received by computer system 102 as part of the customer interaction record.

In some embodiments, computer system 102 or any other computer system may preprocess the call transcript before making it part of the customer interaction record. For example, computer system 102 may remove personally identifiable information (PII) from the transcript, such as a customer's social security number, account number, name, password, and/or any other sensitive information. In another example, computer system 102 may remove a portion of the transcript that corresponds to the speech of the customer service representative, leaving only the speech of the customer. To this end, the customer interaction transcript may include metadata indicating the speaker of each transcribed phrase. In yet another example, computer system 102 may remove certain common words and/or phrases, such as greetings, words of thanks, and similar utterances.

In other embodiments, computer system 102 may also enrich the transcript by, for example, processing the transcript to address one or more issues (e.g., transcription errors) before using the transcript as input into a machine learning model. It should be noted that the enrichment process may be performed during preprocessing of the transcript, after preprocessing of the transcript, or after the transcript is already a part of the customer interaction record. Such issues may arise from the imperfect generation of raw transcripts, which result in errors that cause the raw transcript to be difficult to process by a machine learning model, thereby discouraging the use of such raw transcripts for automated analysis. In one example, an error may result from the incorrect transcription of words. More specifically, the transcription software may misinterpret a first set of one or more words for a second set of one or more words, in which the second set of one or more words may have similar sound or pronunciation (but may have different meaning and/or spelling) to the first set of one or more words. As such, when using the transcription software, “mutual funds” may be transcribed to “mutual phones,” “ETFs” may be transcribed to “E T apps,” and “I didn't know” may be transcribed to “I did unknown.” Computer system 102 may address (e.g., via enrichment process) the aforementioned problem by modifying the transcript to include the correct words.

In another example, computer system 102 may process (e.g., via enrichment process) errors that may be related to the absence of one or more boundaries (e.g., symbols or punctuation marks) that perform separation between clauses, sentences, and/or phrases. In other words, the lack of boundaries may be the result of the transcription software not being capable of identifying whether a set of one or more words constitute a sentence, clause, or phrase. Indeed, this is rendered more difficult by the fact that conversations between two or more persons often include interruptions, in which spoken words from the two or more persons are mixed together, thereby causing difficulty in determining the completed sentence, phrase, or clause spoken by each person. For example, a single spoken sentence may appear broken into multiple transcript sentences that may even include utterances from the other party to the call. As a result of being unable to identify completed sentences, clauses, or phrases, the transcription software may erroneously assume that each set of words uttered in a series without interruption constitutes a completed sentences, clause, or phrase. Such assumption has a negative effect on the machine learning model, as when the model processes the raw transcript, it may not correctly identify the meaning, context, and/or sentiment of the words or even identify the proper boundaries of sentences, clauses, or phrases.

An example of a conversation between a customer C and a customer service agent A erroneously broken up into multiple “sentences” may appear in the transcript as follows: customer C: Just; agent A: Good; customer C: So you're; agent A: That's: customer C: Aware; agent A: Good; agent A: To know. Computer system 102 may process (e.g., enrich) this transcript to determine the group of words spoken by customer C and customer service agent A that form completed sentences, clauses or phrases, and may then modify the raw transcript to reflect such determination, thereby resulting in the following enriched transcript: customer C: “Just so you're aware.”; agent A: “Good. That's good to know.” In addition, it should be noted that the computer system 102 may also add identifiers (e.g., [CLS], [SEP]), symbols, or punction marks to the raw transcript when proper (e.g., period at the end of declarative sentence or a question mark at the end of interrogative clauses), so as to assist the machine learning model in identifying the separation between sentences, clauses, or phrases.

The computer system 102 may further process (e.g., enrichment process) the raw transcript to address issues related to acronyms. Acronyms may be one or more series of letters that each represent a portion of a word. For example, the acronym ETF includes the letters “E,” “T,” and “F,” and corresponds to term “exchange-traded funds.”. In speech, the acronyms are often pronounced as a series of single letters (e.g., “E”, “T”, “F”). Appearances of single letters in a transcript may be determined to be stop words (the most common words in a language) by natural language processing pipelines (which may preprocess data before it is input into the machine learning model), with the result being that such stop words are removed (or filtered) before performing analysis by the machine learning model. Nevertheless, because some acronyms may carry substantial meaning (e.g., in sentiment or contextual analysis), their removal may cause the machine learning model to perform incorrect analysis of the raw transcript, and therefore generate erroneous output. As such, computer system 102 may enrich a transcript including the letters “E. T. F.” by combining them into the single acronym “ETF.” Such acronym may then not be considered a stop word, and therefore may not be removed by the natural language processing pipelines.

Computer system 102 may also address issues related to masking (e.g., via the enrichment process). Masking may involve the concealing of one or more characters (e.g., letters, symbols, or numerals) within the raw transcript via redaction or replacement with random characters. For example, the transcription software may include masking algorithms that are employed to remove PII by masking characters in the transcript (e.g., parts of common words or simple numerals) that are considered to be confidential information. However, the masking algorithm may not always correctly identify confidential information. In other words, the masking algorithm may unintentionally mask one or more non-confidential characters. For example, a masking algorithm may transform the utterance “Give me one second” to “Give me [NUMBER REDACTED] second.” Computer system 102 may reverse the masking during the enrichment process if the sentence is not related to PII.

Computer system 102 may also perform a process (e.g., enrichment process) related to the removal of conversational noise or small talk to, for example, improve the performance of the machine learning model. Conversational noise may be spoken sounds that provides no importance to the conversation (e.g., “mhm”). Small talk may be a sub-conversation that has no bearing on the conversation (e.g., discussion about the weather). In some embodiments, computer system 102 may perform the transcript enrichment in a specific sequence. For example, computer system 102 may clean the transcript by removing markers corresponding to pauses and removing conversational sounds such as “mhm” before performing more complex processes (e.g., adding punctuation and/or determining appropriate replacements for erroneously redacted words, as discussed above).

For other channels, similar customer interaction transcripts are received by computer system 102. A transcript of an online chat session may include a copy of the chat itself. Similarly, a transcript for an email interaction may include a copy of the email. A transcript for a virtual assistant interaction or social media interaction may include a textual copy of the interaction. A transcript for an interaction with a mobile app or a website may include a click stream, i.e., a sequence of interactive elements (buttons, links, etc.) that the customer clicked on while interacting with the website or mobile app. The click stream may include additional metadata such as time information, i.e., how much time the customer spent in various sections of the app or website. Each of these transcripts and/or click streams may be preprocessed and/or enriched by computer system 102 as described above.

In step 220, the computer system 102 provides the plurality of customer interaction transcripts as inputs to a machine learning model. The transcripts may have been preprocessed by computer system 102 before being used as model inputs. Computer system 102 may also perform any other suitable processing steps before providing the transcripts to the machine learning model.

The machine learning model may be any suitable model to process textual transcripts known to the skilled person. Illustratively, the machine learning model is a generative sequence-to-sequence (seq2seq) deep neural network. Seq2seq describes a family of machine learning models used for natural language processing, including language translation, image captioning, conversational models, and text summarization Seq2seq uses sequence transformation, i.e., it turns one sequence of words into another sequence of words. In the example provided herein, the machine learning model may be a Siamese network and may be trained to turn the sequence of words included in a customer interaction transcript into two sequences of words describing a theme and a summary of the transcript, as described below. The machine learning network may have been trained using call transcripts and associated notes from customer service representatives. The notes provide a summary and a theme of each transcript and are used as training data for the machine learning model.

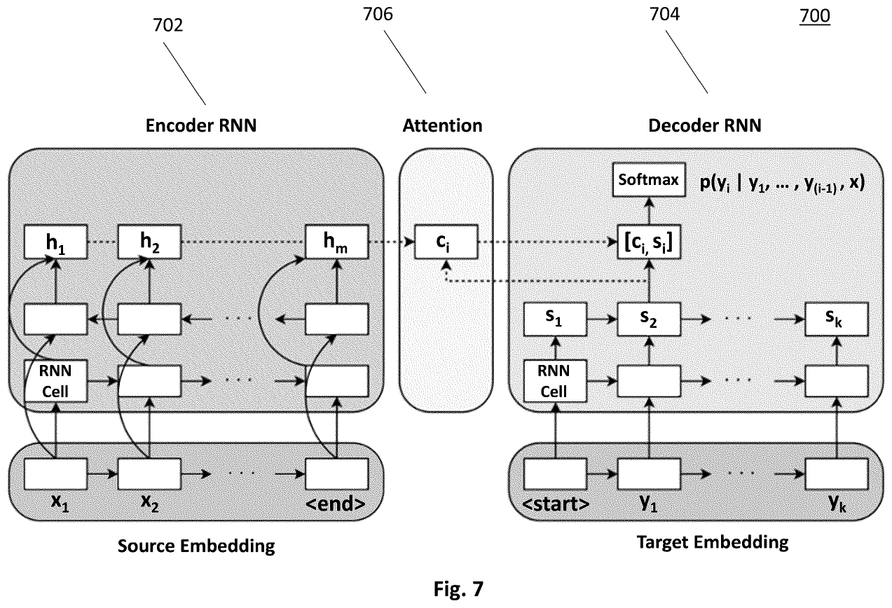

FIG. 7 illustrates the architecture of an exemplary machine learning model 700. In some embodiments, machine learning model 700 may include a language model or large language model (LLM). Machine learning model 700 includes two stacked long short-term memory networks (LSTMs) 702 and 704. LSTMs are recurrent neural networks aimed to operate on sequential data, for example classifying, processing, and predicting data based on time series, such as speech recognition, handwriting recognition, machine translation, and others. Stacked LSTMs are an extension of LSTMs that have multiple hidden LSTM layers. These hidden layers make the model deeper and allow the model to successfully address more challenging classification or prediction problems. The machine learning model 700 may be a stacked bi-LSTM sequence-to-sequence model with attention. Each one of the two LSTMs 702 and 704 may include three, four, five, or six layers.

In some embodiments, the machine learning model 700 may comprise a transformer that includes an encoder and a decoder, in which model 702 serves as an encoder, and model 704 serves as a decoder. The transformer may, for example, accept a model input, which includes, for example, a call transcript. Encoder 702 may be connected to a word embedding layer which determines (continuous-valued) vector representations of each word in the sequential data and a positional encoding layer that adds positional information to the word vectors generated by the word embedding layer. Encoder 702 may include a first multi-headed self attention mechanism that performs a self attention process multiple times in parallel. In a self attention process, attention weights for each of the word vectors generated by the positional encoding layer are determined based on the rest of the other words in the sequential data (e.g., which words are closely related to each other). More specifically, the relationship of a marked word with other words in the sequential data a represented by the attention weights. As such, words having high attention weights demonstrate a strong relationship with the marked word and words that have low attention weights demonstrate a weak relationship with the marked word. By performing such process multiple times in parallel, the resultant attention weights allow for capturing intricate relationships between words in the sequential data, thus enhancing understanding of the context or sentiment of the words themselves. In addition, the encoder 702 may also include a feed forward neural network that processes the output of the multi-head attention mechanism into a form that is proper for the decoder 704.

The decoder 704 receives encoder output from the encoder 702, and uses such encoder output and its own decoder output to generate a model output. For example, the model output may include an interaction theme and an interaction summary associated with the call transcript used as the model input. The decoder 704 may include a second multi-headed self attention mechanism and a third multi-headed self attention mechanism, both of which being similar to the first multi-headed self attention mechanism included in the encoder 702. Initially, the third multi-headed mechanism uses the encoder output to generate a list of words, in which one of the words in list of words is to be the first word in the model output. The list of words is passed to a softmax function, which determines the probability of each word in the list of words. In some embodiments, the decoder 704 may also include a feed forward neural network to modify the list of words into a proper form for the softmax function. The word with the highest probability is selected as the first word in the model output. Next, the first word is used as input into the second multi-headed attention mechanism. In some embodiments, the decoder 704 includes word embedding layer and a positional encoding layer (both of which similar to the corresponding layers in the encoder 702). The first word may be modified by the word embedding layer and the positional encoding layer into a (continuous-valued) vector representation before being input into the second multi-headed attention mechanism.

The second multi-headed attention mechanism determines the attention weight for the first word. The output generated by the second multi-headed attention mechanism is used as input (along with the encoder output) into the third multi-headed attention mechanism to determine the next list of words in which one of the words in next list of words is to be the next word (immediately after the first word) in the model output. Like previously, the next list of words is passed to the softmax function, which selects the next word from the next list of words. Such loop continues until the machine learning model 700 determines that model output is completely generated (e.g., until an end token is generated or the interaction theme and an interaction summary is generated). In some embodiments, encoder 702 encodes input sequences into a fixed-length internal vector, and decoder 704 decodes the fixed-length internal vector to an output sequence. In other embodiments, the transformer may also include an attention module 706, which enhances the functionality of machine learning model 700 by freeing the encoder-decoder architecture from the fixed-length internal vector, as known to the person skilled in the art.

Computer system 102 provides the transcripts to the machine learning model in any suitable way to known to the skilled person. If the machine learning model is hosted on a machine learning platform, such as platform 112, the computer system 102 may transmit the transcripts to the machine learning model over network 110. If the machine learning model is executed within computer system 102, the transcripts may be provided to the model over the file system or memory 106 of computer system 102. In another example, the customer interaction records and associated transcripts may be stored in database 114. Computer system 102 then may transmit identifiers of database records to the machine learning model, and the machine learning model may access database 114 to retrieve the customer interaction transcripts corresponding to those identifiers.

In step 230, computer system 102 causes execution of the machine learning model on machine learning platform 112. Depending on where the machine learning model is executed, computer system 102 may cause execution in any way known to the skilled person. If the model is hosted on a publicly available machine learning platform such as Amazon SageMaker, the computer system 102 may cause execution of the machine learning model using an API provided by the platform. In another example, computer system 102 may cause execution of the machine learning model on an in-house server system by directly connecting to the server system and executing an application or a script that accesses a model already present on the system. It is also expressly contemplated that the computer system 102 provides a copy of the trained machine learning model to a server system before causing execution of the model. Exemplarily, this copy may be a binary file stored in database 114 or in a file system of the computer system 102 that is transmitted to the machine learning platform 112.

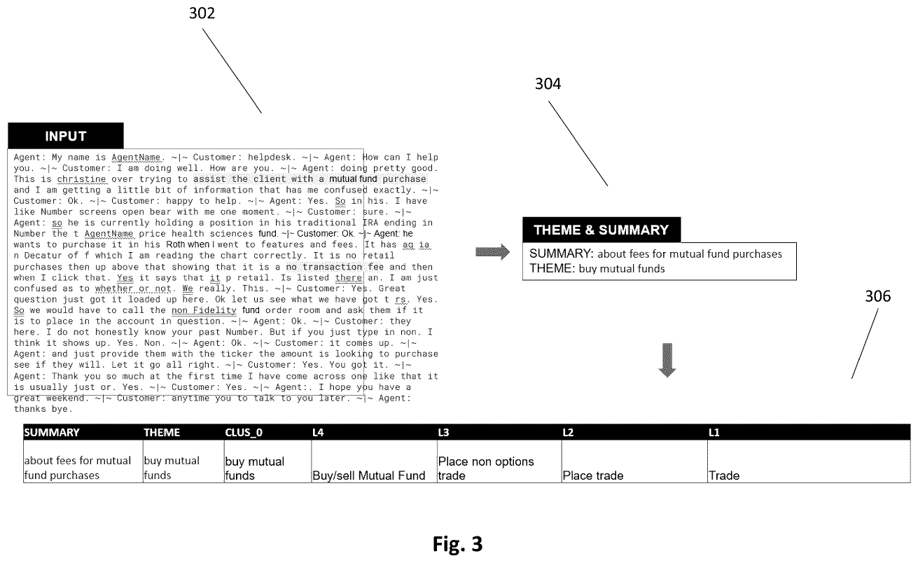

Execution of the machine learning model results in a model output that includes an interaction theme and an interaction summary associated with each transcript of the plurality of customer interaction transcripts. FIG. 3 shows an illustrative interaction theme and interaction summary 304 for an exemplary interaction 302. In some embodiments, the interaction summary may be a one-line summary including 6-18 words, or more than 5 and less than 20 words. Such one-line summaries having such aforementioned characteristics were determined to be the most informative and had the least amount of noise for the purpose of the processing described herein. The interaction theme may be an shorter classification of the interaction (e.g., including 2-5 words). A suitable word count for the interaction theme, may be determined, for example, by training the machine learning model on sample model outputs and/or calculating their median word count. As can be seen, exemplary customer interaction transcript 302 includes a conversation between a customer and a customer service representative/agent pertaining to a purchase of mutual funds. The customer would like to know whether any fees would be charged for purchasing those funds. Accordingly, the summary 304 of the transcript is generated by the model as “about fees for mutual fund purchases.” The theme, an even shorter classification, is generated as “buy mutual funds.” Both interaction theme and interaction summary 304 are associated with the customer interaction transcript 302.

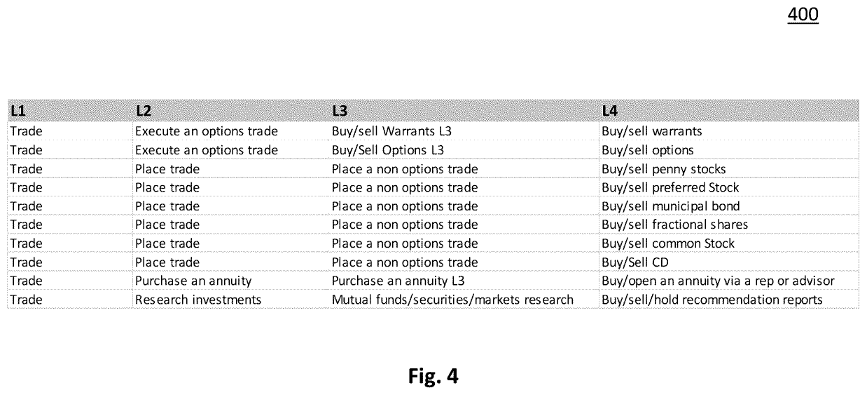

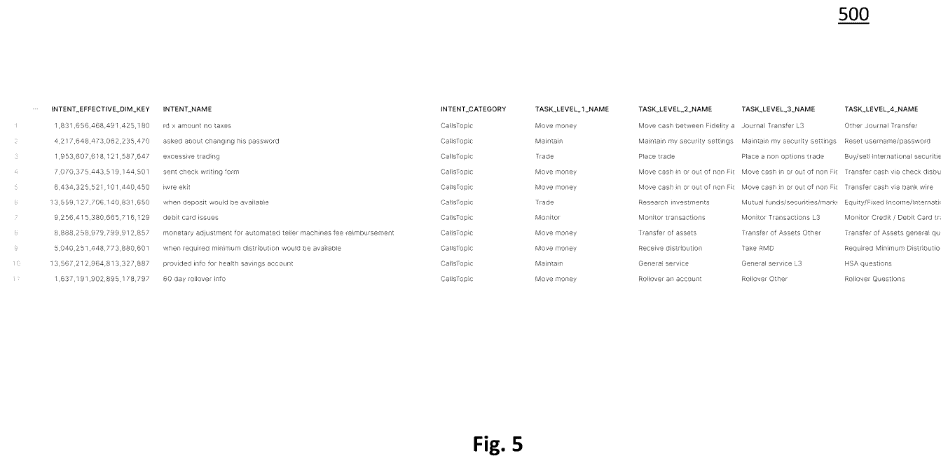

In step 240, the computer system 102 clusters the plurality of interaction themes using a multi-level taxonomy. The taxonomy is a hierarchical, multi-level taxonomy of customer-focused tasks that describes the activities that a customer may complete throughout the customer's relationship with the business. Illustratively, the taxonomy has four levels, labeled L1, L2, L3, and L4. Labels at the L1 level are generic. Their specificity increases throughout the L2 and L3 levels. Labels at the L4 level are specific and granular. An example of a taxonomy for a financial business is shown in FIG. 4. The exemplary taxonomy 400 shows ten different labels at the L4 level. These ten L4 labels can all be grouped under a single L1 label, “Trade.” The L2 labels shown are more specific than the L1 “trade” label. The L3 labels are even more specific than the L2 labels. As can be seen, the specificity of labels increases from L1 to L4. While ten L4 labels are shown here, the multi-level taxonomy may have any suitable number of labels, which is usually a much larger number. In an example, the taxonomy used by computer system 102 may include 616 labels at the L4 level, mapped to 153 labels at the L3 level, mapped to 107 labels at the L2 level, mapped to 9 labels at the L1 level. FIG. 5. shows another exemplary taxonomy 500 for mapping and clustering interaction themes associated with a financial business. Each interaction theme, or intent, in this taxonomy is mapped to labels at four different levels. The 11 interaction themes are hierarchically clustered and mapped to more general labels, arriving at 4 different labels at the L1 level: “move money”, “maintain”, “trade”, and “monitor.” As can be seen, the labels are more specific at the L2 level and further increase in specificity up to the L4 level.

In some embodiments, the taxonomy may have been generated by a collaboration of subject matter experts across various business lines based on their understanding of customer actions and interactions with the business (and/or the field of the business in general) and the objectives of the customers with respect to the business. The various levels of the taxonomy may be based on an understanding of the needs of the business's customers, the jobs that the customers are trying to get done, and the metrics the customers use to measure success.

The clustering results in a plurality of clustered themes associated with each one of the plurality of interaction themes. An example of an interaction theme and associated clustered themes is shown in table 306 of FIG. 3. The interaction summary and interaction theme shown in table 306 are the ones generated by the machine learning model from transcript 302, for example as described above with reference to step 230. The base level of the clustered themes is shown as CLUS_0 and reflects the theme of the interaction. The base level may be included in the plurality of clustered themes. Also shown are the outputs of four different levels of clustering the interaction them using a four-level taxonomy. The fourth level, L4, is a slight generalization of the interaction theme. Illustratively, the theme of “buy mutual funds” is generalized to an L4 clustered theme of “buy/sell mutual fund.” The next level, L3, is a further generalization of the L4 level. Here, an L4 theme of “buy/sell mutual fund” is generalized to “place non options trade.” The second level, L2, is yet another generalization of level L3. The L3 theme of “place non options trade” is generalized to “place trade.’ Finally, the first level, L1, is a very general description of the underlying theme. Here, the L2 theme of “place trade” is generalized to “trade.” The interaction theme “buy mutual funds” is therefore now associated with the clustered themes of “trade”, “place trade”, “place non options trade”, and “buy/sell mutual fund”, in order of increasing specificity from L1 to L4. Any of the clustered themes, or labels, may be used to access and analyze the customer interaction record associated with it.

In step 250, the computer system 102 maps the pluralities of clustered themes and the pluralities of interaction summaries to interaction reasons. The mapping results in an interaction reason associated with each customer interaction record of the plurality of customer interaction records. The interaction reasons may be taken from the taxonomy, or they may be a different set of labels that are mapped to the taxonomy. For example, the labels may correspond to the interaction theme (e.g., one of the outputs of the machine learning model 700), which represents the identified intent of the conversation. The interaction theme may then be mapped to the appropriate taxonomy task (e.g., L1 or L4). In other words, the interaction theme identified by the machine learning model 700 may be part of the taxonomy, or it may be mapped to an appropriate task or entry in the taxonomy. The mapping may be different for different channels of interaction. It is also expressly contemplated that the set of interaction reasons may be different for successive executions of step 250. For example, in a first execution, computer system 102 may map the pluralities of clustered themes and interaction summaries to interaction reasons that mimic the labels at the L1 level of the taxonomy. Using the example shown in table 306, the interaction summary “about fees for mutual fund purchases” and the theme “buy mutual funds” may be mapped to the interaction reason “trade.” In another execution, computer system 102 may map the pluralities of clustered themes and interaction summaries to interaction reasons that mimic the labels at the L3 level of the taxonomy. In the example of table 306, the interaction summary may then be mapped to the interaction reason “place non options trade.” It is also noted that the computer system 102 may map the clustered themes and interaction summaries to more than one interaction reason. For example, the computer system 102 may map each set of clustered themes associated with an interaction summary to four interaction reasons corresponding to the labels at levels L1, L2, L3, and L4 of the taxonomy. At the conclusion of step 250, at least one interaction reason is associated with each customer interaction record.

In step 260, the computer system 102 stores the integrated data associated with each customer interaction record in the plurality of customer interaction records in a database, such as database 114. Specifically, the computer system 102 stores the interaction reason associated with each customer interaction record, as mapped in step 250, in the database.

Notably, computer system 102 may be configured to execute method 200 periodically. For example, computer system 102 may be configured to execute method 200 once an hour, once a day, or at any other suitable time period. In other embodiments, computer system 102 may be configured to execute method 200 based on certain triggers. For example, computer system 102 may execute method 200 whenever a new customer interaction record is stored in a database such as database 114. This ensures that the integrated and stored data is always up to date.

The stored data can then be used for any suitable kind of analysis. Illustratively, the computer system 102 may aggregate the data so that a user can see why or for what reason a certain customer interacted with the business. The computer system 102 may retrieve a plurality of data records associated with a certain query customer identifier from the database 114. Each data record includes a query interaction reason, which is the reason for the customer's interaction with the business for that given data record. For example, the computer system 102 may retrieve five data records for a given query customer identifier from the database 11. Illustratively, the query interaction reasons of the five data records are “buy mutual funds”, “move money”, “buy mutual funds”, “password reset”, and “buy mutual funds.” The computer system 102 then aggregates the data records by query interaction reason. In the example above, the aggregation would result in three of the records being associated with the interaction reason “buy mutual funds”, one associated with the interaction reason “move money”, and one associated with the interaction reason “password reset.” The computer system 102 may then cause display of the aggregated data. To this end, the computer system 102 may display the aggregated data on a display device, such as a monitor, coupled to computer system 102. In other embodiments, the computer system 102 may cause display of the aggregated data on a different computer system or server system. For example, the computer system 102 may transmit the aggregated data over the network 110 to a web server coupled to the network so that the aggregated data can be displayed on a website served by that web server.

In another example, computer system 102 may aggregate the data so that a user can see which customers had a certain reason for their interaction. The computer system 102 may retrieve a plurality of data records associated with a certain query interaction reason, for example “buy mutual funds”, from the database 114. The query interaction reason may be selected from any suitable taxonomy level. If the database stores interaction reasons for all levels of the taxonomy for each customer interaction record, the query interaction reason may be selected from any level of the taxonomy. The computer system 102 then receives the data records from the database. Each data record includes a query customer identifier, which is an identifier of a customer who interacted with the business for the given interaction reason. The computer system 102 may then aggregate the data by query customer identifier. Illustratively, the result of the aggregation may be that customer X interacted with the business 15 times to buy mutual funds, customer Y interacted with the business 22 times to buy mutual funds, and customer Z interacted with the business 3 times to buy mutual funds. The computer system 102 then causes display of the aggregated data as described above.

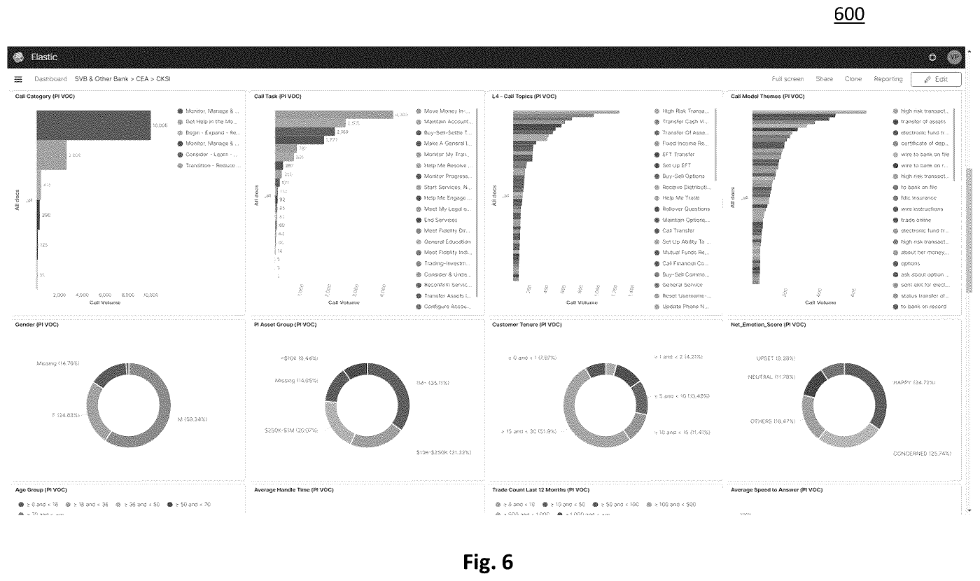

It is also expressly contemplated that the integrated data may be used for further data analysis and display. For example, the integrated data may be used with a data analysis and visualization platform such as ElasticStack or ELK Stack, publicly available from Elastic NV (Amsterdam, The Netherlands). The data analysis and visualization platform may retrieve the integrated data from the database 114 and combine it with additional data, such as data related to the respective customer (profile, customer demographics, household income. customer assets), data related to the business transaction associated with a certain customer interaction record, and/or any other suitable data. Such data analysis can then help the business to understand potential customer friction points, trending topics in customer interaction, critical issues during customer interactions, typical pathways of customer interactions, and any other desired business insight. FIG. 6 shows an exemplary graphical output 600 of a data analysis and visualization platform. The top row of the visualization shows the data integrated by the method and system described herein, specifically the interaction reason for each customer interaction record retrieved from the database at different levels of the taxonomy. The top left chart shows the interaction reason at the most general level of the taxonomy, L1. The chart to the right of it shows the interaction reason at a more specific level of the taxonomy, such as L2 or L3. The chart to the right of that shows the interaction reason at the most specific L4 level of the taxonomy. The chart on the far right of the top row shows the theme of the interaction as determined by the machine learning model. The other rows of the visualization show information related to the customers associated with the customer interaction records retrieved, such as customer gender, amount of assets held by the customer, tenure of the customer, i.e., how long the customer has been a customer, and other data such as age group and trade count.

Embodiments of the present invention may be embodied in many different forms, including, but in no way limited to, computer program logic for use with a processor (e.g., a microprocessor, microcontroller, or digital signal processor), programmable logic for use with a programmable logic device (e.g., a Field Programmable Gate Array (FPGA) or other PLD), discrete components, integrated circuitry (e.g., an Application Specific Integrated Circuit (ASIC)), or any other means including any combination thereof.

Computer program logic implementing all or part of the functionality previously described herein may be embodied in various forms, including, but in no way limited to, a source code form, a computer executable form, and various intermediate forms (e.g., forms generated by an assembler, compiler, networker, or locator.) Source code may include a series of computer program instructions implemented in any of various programming languages (e.g., an object code, an assembly language, or a high-level language such as Fortran, C, C++, Python, JAVA, or HTML) for use with various operating systems or operating environments. The source code may define and use various data structures and communication messages. The source code may be in a computer executable form (e.g., via an interpreter), or the source code may be converted (e.g., via a translator, assembler, or compiler) into a computer executable form.

The computer program may be fixed in any form (e.g., source code form, computer executable form, or an intermediate form) either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM), a PC card (e.g., PCMCIA card), or other memory device. The computer program may be fixed in any form in a signal that is transmittable to a computer using any of various communication technologies, including, but in no way limited to, analog technologies, digital technologies, optical technologies, wireless technologies, networking technologies, and internetworking technologies. The computer program may be distributed in any form as a removable storage medium with accompanying printed or electronic documentation (e.g., shrink wrapped software or a magnetic tape), preloaded with a computer system (e.g., on system ROM or fixed disk), or distributed from a server or electronic bulletin board over the communication system (e.g., the Internet or World Wide Web).

Hardware logic (including programmable logic for use with a programmable logic device) implementing all or part of the functionality previously described herein may be designed using traditional manual methods, or may be designed, captured, simulated, or documented electronically using various tools, such as Computer Aided Design (CAD), a hardware description language (e.g., VHDL or AHDL), or a PLD programming language (e.g., PALASM, ABEL, or CUPL).

The foregoing description described certain example embodiments. It will be apparent, however, that other variations and modifications may be made to the described embodiments, with the attainment of some or all of their advantages. Accordingly, the foregoing description is to be taken only by way of example, and not to otherwise limit the scope of the disclosure. It is the object of the appended claims to cover all such variations and modifications as come within the true spirit and scope of the disclosure.

What is claimed is:

1. A computer-implemented method for integrating customer interaction data from a plurality of channels and for a plurality of customers, the method comprising:
receiving, by a computer system, a plurality of customer interaction records, each record associated with a channel from the plurality of channels and an identifier of a customer from the plurality of customers, each record including a customer interaction transcript;
providing, by the computer system, the plurality of customer interaction transcripts as inputs to a machine learning model;
causing, by the computer system, execution of the machine learning model, the execution resulting in a model output including an interaction theme and an interaction summary associated with each one of the plurality of customer interaction transcripts;
clustering, by the computer system, the plurality of themes using a multi-level taxonomy, the clustering resulting in a plurality of clustered themes associated with each one of the plurality of themes;
mapping, by the computer system, the pluralities of clustered themes and the plurality of interaction summaries, the mapping resulting in an interaction reason associated with each one of the plurality of customer interaction records; and
storing, by the computer system, the interaction reason associated with each one of the plurality of customer interaction records in a database.

2. The computer-implemented method of claim 1, wherein the machine learning model is a sequence-to-sequence model.

3. The computer-implemented method of claim 1, wherein the multi-level taxonomy is a hierarchical taxonomy.

4. The computer-implemented method of claim 1, wherein the multi-level taxonomy includes at least four levels.

5. The computer-implemented method of claim 1, further comprising:
retrieving, by the computer system, a plurality of data records associated with a query customer identifier from the database, each data record including a query interaction reason;
aggregating, by the computer system, the plurality of data records by query interaction reason; and
causing, by the computer system, display of the aggregated data.

6. The computer-implemented method of claim 1, further comprising:
retrieving, by the computer system, a plurality of data records associated with a query interaction reason from the database, each data record including a query customer identifier;
aggregating, by the computer system, the plurality of data records by query customer identifier; and
causing, by the computer system, display of the aggregated data.

7. The computer-implemented method of claim 1, wherein at least one record of the plurality of customer interaction records is associated with a channel different from the channel associated with another record of the plurality of customer interaction records.

8. The computer-implemented method of claim 1, wherein the computer system is configured to execute the method periodically.

9. The computer-implemented method of claim 1, wherein each theme of the plurality of themes includes five words or less.

10. The computer-implemented method of claim 1, wherein each summary of the plurality of summaries includes more than five words and less than twenty words.

11. A system for integrating customer interaction data from a plurality of channels and for a plurality of customers, the system comprising:
a database; and
a computer system having a processor coupled to a memory, the computer system communicatively coupled to the database, the processor configured to:
receive a plurality of customer interaction records, each record associated with a channel from the plurality of channels and an identifier of a customer from the plurality of customers, each record including a customer interaction transcript;
provide the plurality of customer interaction transcripts as inputs to a machine learning model;
cause execution of the machine learning model, the execution resulting in a model output including an interaction theme and an interaction summary associated with each one of the plurality of customer interaction transcripts;
cluster the plurality of themes using a multi-level taxonomy, the clustering resulting in a plurality of clustered themes associated with each one of the plurality of themes;
map the pluralities of clustered themes and the plurality of interaction summaries, the mapping resulting in an interaction reason associated with each one of the plurality of customer interaction records; and
store the interaction reason associated with each one of the plurality of customer interaction records in the database.

12. The system of claim 11, wherein the machine learning model is a sequence-to-sequence model.

13. The system of claim 11, wherein the multi-level taxonomy is a hierarchical taxonomy including at least four levels.

14. The system of claim 11, wherein the processor is further configured to:
retrieve a plurality of data records associated with the identifier of the customer from the database, each data record including a query interaction reason;
aggregate the plurality of data records by query interaction reason; and
cause display of the aggregated data.

15. The system of claim 11, wherein the processor is further configured to:
retrieve a plurality of data records associated with a query interaction reason from the database, each data record including a query customer identifier;
aggregate the plurality of data records by query customer identifier; and
cause display of the aggregated data.

16. The system of claim 11, wherein at least one record of the plurality of customer interaction records is associated with a channel different from the channel associated with another record of the plurality of customer interaction records.

17. The system of claim 11, wherein the processor is configured to execute the method periodically.

18. The system of claim 11, wherein each theme of the plurality of themes includes five words or less.

19. The system of claim 11, each summary of the plurality of summaries includes more than five words and less than twenty words.

20. A non-transitory computer-readable medium having software encoded thereon, the software, when executed by a computer system coupled to database, operable to:
receive a plurality of customer interaction records, each record associated with a channel from the plurality of channels and an identifier of a customer from the plurality of customers, each record including a customer interaction transcript;
provide the plurality of customer interaction transcripts as inputs to a machine learning model;
cause execution of the machine learning model, the execution resulting in a model output including an interaction theme and an interaction summary associated with each one of the plurality of customer interaction transcripts;
cluster the plurality of themes using a multi-level taxonomy, the clustering resulting in a plurality of clustered themes associated with each one of the plurality of themes;
map the pluralities of clustered themes and the plurality of interaction summaries, the mapping resulting in an interaction reason associated with each one of the plurality of customer interaction records; and
store the interaction reason associated with each one of the plurality of customer interaction records in the database.
